(19) United States
(12) Patent Application Publication
(10) Pub. No.: US 2026/0027002 A1
(43) Pub. Date: Jan. 29, 2026

(54) MASSAGE COMPONENT WITH LEAD-IN GROOVE AND CLAMPING GROOVE

(71) Applicant: Zhejiang Red And Black Technology Co., Ltd, Lishui (CN)

(72) Inventors: Xinyi Shu, Jinyun (CN); Lifeng Shu, Jinyun (CN)

(21) Appl. No.: 18/822,119

(22) Filed: Aug. 31, 2024

(30) Foreign Application Priority Data
Jul. 26, 2024 (CN) 2024217960784

(51) Int. Cl. A61H 23/00

(52) U.S. Cl. CPC A61H 23/006; A61H 2201/0107

(57) ABSTRACT

A massage component with a lead-in groove and a clamping groove includes a massage head and a massage connecting member. An inner side of the massage connecting member is provided with the lead-in groove and the clamping groove, and the clamping groove is annularly arranged on the massage connecting member. One end of the lead-in groove extends to a side edge of the massage connecting member, and the other end of the lead-in groove communicates with the clamping groove. The massage head is provided with a protruding point, and the protruding point fits with the clamping groove and the lead-in groove. When the protruding point completely enters the clamping groove, a firm connection is formed between the massage head and the massage connecting member, which ensures stability during massage, and facilitates quick disassembly when the massage head needs to be replaced.

### TECHNICAL FIELD

The present disclosure relates to the field of massager devices, and in particular, to a massage component with a lead-in groove and a clamping groove.

### BACKGROUND

As a widely used health care product, in design, a massage apparatus focuses on providing comfortable massage experience and a convenient use method. Conventional massage apparatuses, especially those devices equipped with replaceable massage heads, are often faced with the problems of complicated design of connecting components, inconvenience in mounting and insufficient connection stability. These shortcomings not only affect a user's massage experience, but also may cause the massage head to fall off during use, thereby causing potential safety hazards to the user.

### SUMMARY

In view of the above situation, it is necessary to provide a massage component with a lead-in groove and a clamping groove for solving at least one of the above problems, including a massage head and a massage connecting member, where an inner side of the massage connecting member is provided with the lead-in groove and the clamping groove, the clamping groove is annularly arranged on the massage connecting member, one end of the lead-in groove extends to a side edge of the massage connecting member, the other end of the lead-in groove communicates with the clamping groove, the massage head is provided with a protruding point, and the protruding point fits with the clamping groove and the lead-in groove.

Preferably, an abutting member is provided at a joint between the clamping groove and the lead-in groove that are in communication with each other.

Preferably, an end of the massage head is further sleeved with a sealing rubber ring.

Preferably, a sealing member is further sleeved at an abutting part between the massage head and the massage connecting member.

Preferably, the protruding point is located between the sealing rubber ring and the sealing member.

Preferably, outer sides of the massage connecting member and the massage head are both subjected to anti-slip treatment.

### BRIEF DESCRIPTION OF THE DRAWINGS

1. Massage head; 11. Protruding point; 12. Sealing rubber ring; 2. Massage connecting member; 21. Lead-in groove; 22. Clamping groove; 221. Abutting member; 3. Sealing member.

FIG. 1 is a schematic structural diagram of a massage component with a lead-in groove and a clamping groove according to an embodiment of the present disclosure;

FIG. 2 is an exploded view of a massage component with a lead-in groove and a clamping groove according to an embodiment of the present disclosure;

FIG. 3 is a schematic structural diagram of a massage connecting member according to an embodiment of the present disclosure; and

FIG. 4 is a schematic structural diagram of a massage connecting member according to another embodiment of the present disclosure.

### DETAILED DESCRIPTION OF THE EMBODIMENTS

To make the objectives, technical solutions and advantages of the present disclosure clearer, the massage component with a lead-in groove and a clamping groove according to the present disclosure is described in further detail below with reference to the accompanying drawings and embodiments. It should be understood that specific embodiments described herein are merely intended to explain the present disclosure, but are not intended to limit the present disclosure.

In the description of the present disclosure, unless otherwise specified, “a plurality of” means two or more. The directional or positional relationship indicated by the term such as “central”, “longitudinal”, “transverse”, “upper”, “lower”, “left”, “right”, “inside”, “outside”, “front end”, “rear end”, “head”, “tail”, “vertical”, “horizontal”, “top”, and “bottom” is the directional or positional relationship based on the accompanying drawings, and is merely intended to facilitate and simplify the description of the present disclosure, rather than to indicate or imply that the device or element referred to must have a particular direction and be constructed and operated in a particular direction. Therefore, this should not be construed as limiting the present disclosure. Moreover, the terms “first”, “second”, and “third” are merely used for description, and are not intended to indicate or imply relative importance.

In the description of the present disclosure, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

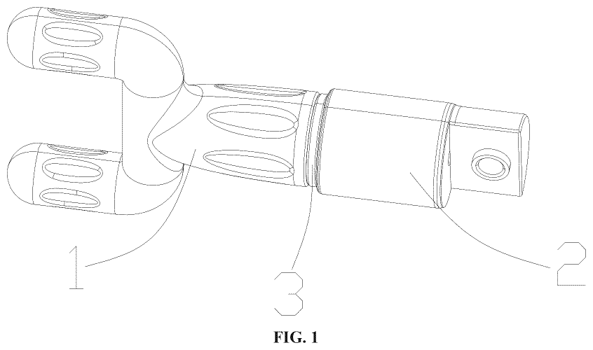

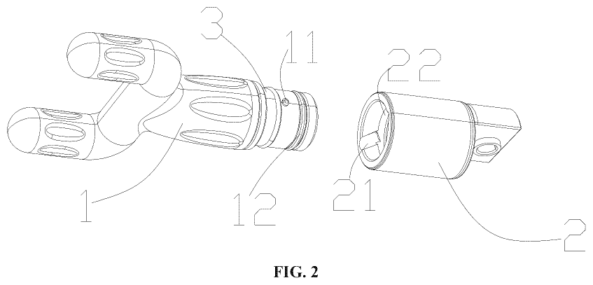

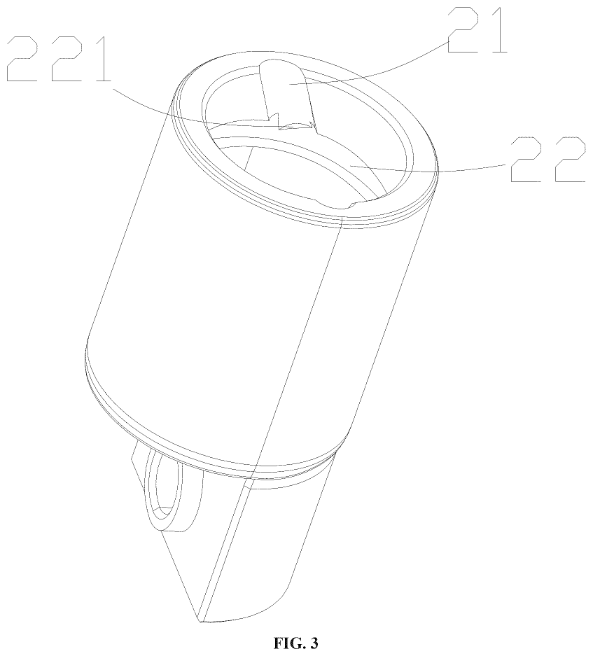

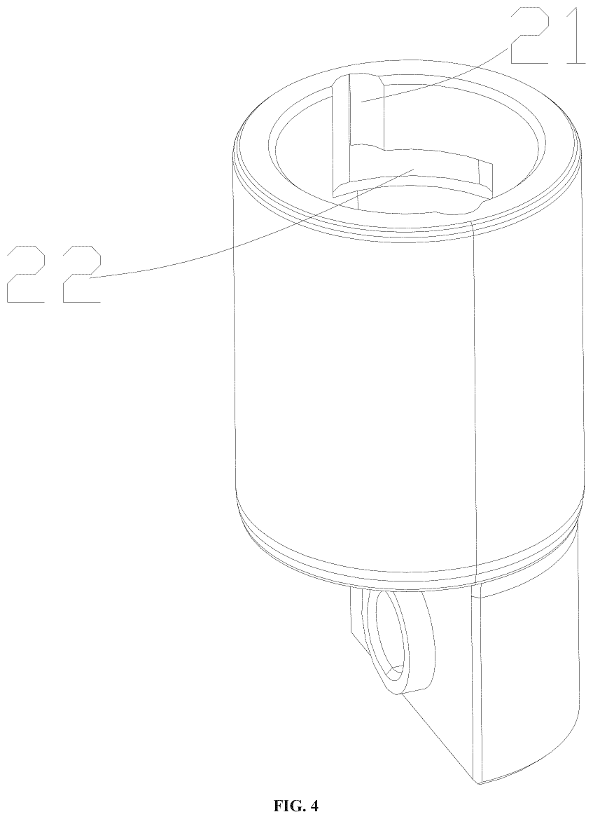

Referring to FIGS. 1 to 4, a massage component with a lead-in groove 21 and a clamping groove 22 according to an embodiment of the present disclosure includes a massage head 1 and a massage connecting member 2. An inner side of the massage connecting member 2 is provided with the lead-in groove 21 and the clamping groove 22, and the clamping groove 22 is annularly arranged on the massage connecting member 2. One end of the lead-in groove 21 extends to a side edge of the massage connecting member 2, and the other end of the lead-in groove 21 communicates with the clamping groove 22. The massage head 1 is provided with a protruding point 11, and the protruding point 11 fits with the clamping groove 22 and the lead-in groove 21.

In the above embodiment, two key portions are meticulously designed on an inner side of the massage connecting member 2 as a core supporting structure of the whole component: the lead-in groove 21 and the clamping groove 22. The clamping groove 22 is of an annular design, and surrounds an inner edge of the massage connecting member 2. This design not only enhances stability of connection, but also ensures that the massage head 1 can be uniformly stressed after being mounted, thereby avoiding damage or looseness caused by local stress concentration. The annular layout of the clamping groove 22 also facilitates accurate positioning of the massage head 1 in all directions, thereby ensuring uniformity and consistency of a massage effect. The design of the lead-in groove 21 greatly improves mounting convenience of the massage head 1. One end of the lead-in groove 21 extends to the side edge of the massage connecting member 2, forming an easily recognizable inlet through which a user or maintenance worker can easily guide the protruding point 11 of the massage head 1 to an interior. The other end of the lead-in groove 21 communicates with the clamping groove 22. This design ensures that the protruding point 11 can smoothly enter the clamping groove 22 after passing through the lead-in groove 21, thereby implementing seamless joint. This process reduces resistance during mounting, and avoids damage caused by an improper operation. Finally, the protruding point 11 on the massage head 1 is designed to fit with the clamping groove 22 and the lead-in groove 21, and the protruding point 11 fits with the clamping groove 22 and the lead-in groove 21 in shape and dimension to ensure that the protruding point can be accurately inserted into the clamping groove 22 and be kept stable. When the protruding point 11 completely enters the clamping groove 22, a firm connection is formed between the massage head 1 and the massage connecting member 2, which ensures stability during massage, and facilitates quick disassembly when the massage head 1 needs to be replaced. To sum up, according to the massage component, a stable and convenient connection between the massage head 1 and the massage connecting member 2 is implemented through an ingenious combination of the lead-in groove 21 and the clamping groove 22 and a precise design of the protruding point 11 on the massage head 1.

Referring to FIGS. 1 to 3, an abutting member 221 is provided at a joint between the clamping groove 22 and the lead-in groove 21 that are in communication with each other.

In the above embodiment, when the protruding point 11 of the massage head 1 slides along the lead-in groove 21 to a deep part of the clamping groove 22 and comes into contact with the abutting member 221, the user can rotate the massage head 1 conveniently. This rotation action causes the protruding point 11 to move along a track of the clamping groove 22 until the protruding point is completely clamped into a locking part of the clamping groove 22. The abutting member 221 not only serves as an end mark of sliding of the protruding point 11, but also helps to complete the rotation locking process of the massage head 1 through the structural characteristics of the abutting member, thereby ensuring mounting stability and operation simplicity.

Referring to FIGS. 1 to 3, an end of the massage head 1 is further sleeved with a sealing rubber ring 12.

In the above embodiment, the sealing rubber ring 12 is closely attached to a contact surface between the massage head 1 and the massage connecting member 2, which effectively prevents external impurities such as dust and moisture from entering an internal structure, thereby protecting a precise mechanical component and a circuit element of the massage component and prolonging the service life. In addition, the sealing rubber ring 12 further achieves a certain buffering effect, reduces direct contact and friction between the massage head 1 and the connecting member, reduces noise, and improves comfortable user experience during use.

Referring to FIGS. 1 to 3, a sealing member 3 is further sleeved at an abutting part between the massage head 1 and the massage connecting member 2.

In the above embodiment, sealing performance of a joint between the massage head and the massage connecting member is ensured, so that external pollutants such as a liquid and dust are prevented from penetrating into the interior, thereby preventing an internal mechanical structure and circuit from being damaged. The sealing member 3 is usually made of an elastic material, which can be closely attached to the contact surface between the massage head 1 and the connecting member, thereby forming an effective sealing barrier. In addition, the sealing member 3 further has a certain buffering effect, which can reduce vibration and noise of the massage head 1 during operation and improve overall use experience and durability.

Referring to FIGS. 1 to 3, the protruding point 11 is located between the sealing rubber ring 12 and the sealing member 3.

In the above embodiment, an additional protective barrier is provided for the protruding point 11, and close attachment of the protruding point 11 to the clamping groove 22 is ensured through the elastic characteristics of the protruding point, thereby implementing multi-level sealing and stable connection, and improving overall performance and durability of the massage component.

Referring to FIGS. 1 to 3, outer sides of the massage connecting member 2 and the massage head 1 are both subjected to anti-slip treatment.

In the above embodiments, the anti-slip treatment is usually implemented by increasing surface roughness, or by using a special material or coating, or the like, aiming at increasing a friction force when a hand is in contact with the component and preventing accidental falling off or out of control caused by hand slip during use.

The above descriptions are only preferred embodiments of the present disclosure, and are not intended to limit the present disclosure in any form. Although the present disclosure has been disclosed by the preferred embodiments above, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification and equivalent change made to the foregoing embodiments according to the technical essence of the present disclosure without departing from the content of the technical solution of the present disclosure shall fall within the scope of the technical solution of the present disclosure.

What is claimed is:

1. A massage component with a lead-in groove and a clamping groove, comprising a massage head and a massage connecting member, wherein an inner side of the massage connecting member is provided with the lead-in groove and the clamping groove, the clamping groove is annularly arranged on the massage connecting member, one end of the lead-in groove extends to a side edge of the massage connecting member, the other end of the lead-in groove communicates with the clamping groove, the massage head is provided with a protruding point, and the protruding point fits with the clamping groove and the lead-in groove.

2. The massage component with a lead-in groove and a clamping groove according to claim 1, wherein an abutting member is provided at a joint between the clamping groove and the lead-in groove that are in communication with each other.

3. The massage component with a lead-in groove and a clamping groove according to claim 1, wherein an end of the massage head is further sleeved with a sealing rubber ring.

4. The massage component with a lead-in groove and a clamping groove according to claim 3, wherein a sealing member is further sleeved at an abutting part between the massage head and the massage connecting member.

5. The massage component with a lead-in groove and a clamping groove according to claim 4, wherein the protruding point is located between the sealing rubber ring and the sealing member.

6. The massage component with a lead-in groove and a clamping groove according to claim 1, wherein outer sides of the massage connecting member and the massage head are both subjected to anti-slip treatment.
